(19) United States
(12) Patent Application Publication
(10) Pub. No.: US 2007/0193796 A1
(43) Pub. Date: Aug. 23, 2007

(54) Economical running control apparatus

(75) Inventor: Kazuhi Yamaguchi, Hyogo (JP)

Correspondence Address: OLIFF & BERRIDGE, PLC, P.O. BOX 19928, ALEXANDRIA, VA, 22320, US

(73) Assignee: FUJITSU TEN LIMITED, Kobe-shi (JP)

(21) Appl. No.: 11/702,068

(22) Filed: Feb. 5, 2007

(30) Foreign Application Priority Data
Feb. 20, 2006 (JP) 2006-042577

(51) Int. Cl. B60V 1/00

(52) U.S. Cl. 180/125

(57) ABSTRACT

An economical running control apparatus is operable to control an economical running in which an engine is automatically stopped when a predetermined engine stopping condition is established and the engine is automatically started when a predetermined engine starting condition is established. The economical running control apparatus is adapted to be mounted on a vehicle including the engine, a first battery operable to supply power to an vehicle mounted electric unit, and a second battery operable to suppress a voltage reduction in the first battery when the engine is started. A judge is operable to judge whether the economical running is permitted or prohibited based on a first quantity of electricity which the first battery is capable of discharging when the engine is started, a second quantity of electricity which the second battery is capable of discharging, and a third quantity of electricity required to completely explode the engine.

The disclosure of Japanese Patent Application No. 2006-042577 filed Feb. 20, 2006 including specification, drawings and claims is incorporated herein by reference in its entirety.

### BACKGROUND

The present invention relates to an economical running control apparatus and more particularly to an economical running control apparatus to perform an economical running in which an engine is automatically stopped when a predetermined engine stopping condition is established and the engine is automatically restarted when a predetermined engine restarting condition is established in a vehicle comprising a primary battery for supplying power to a vehicle mounted electric unit and a secondary battery for suppressing a voltage reduction of the primary battery when the engine is restarted.

There are some vehicles which are equipped with an economical running system in which the engine is automatically stopped when a predetermined engine stopping condition is established and the engine is automatically restarted when a predetermined engine restarting condition is established.

In these vehicles, although no power is generated when the engine is stopped while performing the economical running, the vehicle mounted electric unit such as an in-car audio system can be used. Therefore, the voltage reduction of the battery is expected. When the engine is restored from the economical running and restarted, the power supplied to the vehicle mounted electric unit is limited due to the voltage reduction of the battery. Therefore, it is considered that the vehicle mounted electric unit is reset or the engine cannot be restarted.

In Japanese Patent Publication No. 2002-115578A, in order to prevent the voltage reduction of the battery, a battery voltage value is measured so as to prohibit the engine from being automatically stopped and the economical running is not performed when the voltage reduction is large.

In addition, in Japanese Patent Publication No. 2004-251234A, a secondary battery (a capacitor) is installed on a vehicle for supplementing the voltage reduction of the primary buttery when the engine is restarted. The engine is prohibited from being automatically stopped and the economical running is not performed until the installed secondary battery restores a predetermined charged state.

In the above related-art economical running control systems the economical running is not performed when a dischargeable quantity of electricity is insufficient in the secondary battery, even though the dischargeable quantity of electricity of the primary battery is sufficient to perform the economical running. Therefore, opportunities for performing the economical running are decreased.

### SUMMARY

It is therefore an object of the invention to provide an economical running control system which can facilitates performing the economical running.

In order to achieve the above described objects, according to the invention, there is provided an economical running control apparatus operable to control an economical running in which an engine is automatically stopped when a predetermined engine stopping condition is established and the engine is automatically started when a predetermined engine starting condition is established, the economical running control apparatus adapted to be mounted on a vehicle including the engine, a first battery operable to supply power to an vehicle mounted electric unit, and a second battery operable to suppress a voltage reduction in the first battery when the engine is started, the economical running control apparatus comprising:

a judge operable to judge whether the economical running is permitted or prohibited based on a first quantity of electricity which the first battery is capable of discharging when the engine is started, a second quantity of electricity which the second battery is capable of discharging, and a third quantity of electricity required to completely explode the engine.

With this configuration, since whether the economical running is permitted or prohibited is judged based on both the first and the second power quantities that the first and second batteries can discharge when the engine started, the economical running can be permitted when the second quantity of electricity is larger than a predetermined value, even though the first quantity of electricity is insufficient to perform the economical running. In addition, the economical running can be permitted when the first quantity of electricity of the primary battery larger than a predetermined value, even though the second quantity of electricity is insufficient to perform the economical running. Thus, the opportunities to perform the economical running are increased, whereby the fuel economy of the vehicle can be increased.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a hardware block diagram of an economical running control system according to an embodiment of the present invention;

FIG. 2 is a hardware block diagram of an economical running control apparatus according to the embodiment;

FIG. 3 is a functional block diagram of the economical running control apparatus;

FIG. 4 is a flowchart showing a primary battery state detection process according to the embodiment;

FIG. 5 is a flowchart showing a battery internal resistance value update process according to the embodiment;

FIG. 6 is a diagram showing battery internal resistance value characteristic relative to battery fluid temperature;

FIG. 7 is a flowchart showing a primary battery capacity correction process according to the embodiment;

FIG. 8 is a diagram showing correction coefficient characteristic relative to battery fluid temperature;

FIG. 9 is a diagram showing correction coefficient characteristics relative to battery internal resistance value;

FIG. 10 is a flowchart showing a secondary battery state detection process according to the embodiment;

FIG. 11 is a diagram showing secondary battery capacity characteristics relative to secondary battery voltage value;

FIG. 12 is a diagram showing correction coefficient characteristics of secondary battery capacity relative to battery ambient temperature;

FIG. 13 is a flowchart, showing a voltage reduction quantity calculation process according to the embodiment;

FIG. 14 is a flowchart showing a voltage reduction quantity update process according to the embodiment;

FIG. 15 is a flowchart showing a primary economical running permission determination process according to the embodiment;

FIG. 16 is a flowchart showing a secondary economical running permission determination process according to the embodiment;

FIG. 17 is a flowchart showing an capacity update process according to the embodiment; and

FIG. 18 is a flowchart showing an automatic engine restarting process according to the embodiment.

### DETAILED DESCRIPTION OF THE EMBODIMENTS

Hereinafter, an embodiment of the invention will be described in detail with reference to the accompanying drawings.

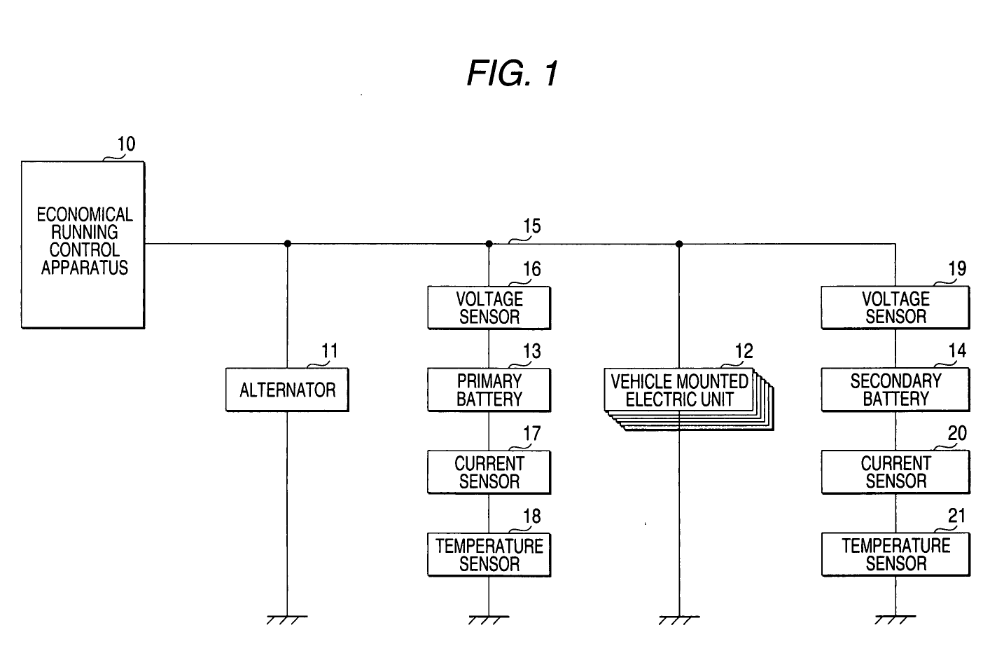

As shown in FIG. 1, the economical running control system includes an economical running control apparatus 10 for controlling and performing an economical running, and an alternator 11 for generating power when an engine is activated, a vehicle mounted electric unit 12, a primary battery 13 for supplying power to the vehicle mounted electric unit 12 and a secondary battery 14 (for example, a battery such as a capacitor) for suppressing voltage reduction in the primary battery 13 when the engine is restarted are connected to the economical running control apparatus 10 via a power supply line 15.

A voltage sensor 16 for detecting voltage, a current sensor 17 for detecting current and a temperature sensor 18 for detecting temperature are provided on the primary battery 13, and although not shown, output terminals of the voltage sensor 16, current sensor 17 and temperature sensor 18 are connected to the economical running control apparatus 10. In addition, a voltage sensor 19, a current sensor 20 and a temperature sensor 21 are provided on the secondary battery 14, and although not shown, output terminals of the voltage sensor 19, current sensor 20 and temperature sensor 21 are connected to the economical running control apparatus 10.

The vehicle mounted electric unit 12 is an electric unit installed on the vehicle and includes, for example, an electronic control unit for an engine control system and a brake control system and an in-car audio system.

Based on signals detected by the voltage sensor 16, the current sensor 17 and the temperature sensor 18 of the primary battery 13, and signals detected by the voltage sensor 19, the current sensor 20 and the temperature sensor 21 of the secondary battery 14, the economical running control apparatus 10 calculates a discharged quantity of electricity which is discharged from the primary battery 13 while the primary battery voltage value of the primary battery 13 changes by a predetermined voltage, a dischargeable quantity of electricity which the secondary battery 14 can discharge and a voltage reduction quantity in voltage value of the primary battery from a start of the engine to a complete explosion of the engine. The economical running control apparatus 10 determines whether the apparatus permits or prohibits an economical running based on results of the calculations.

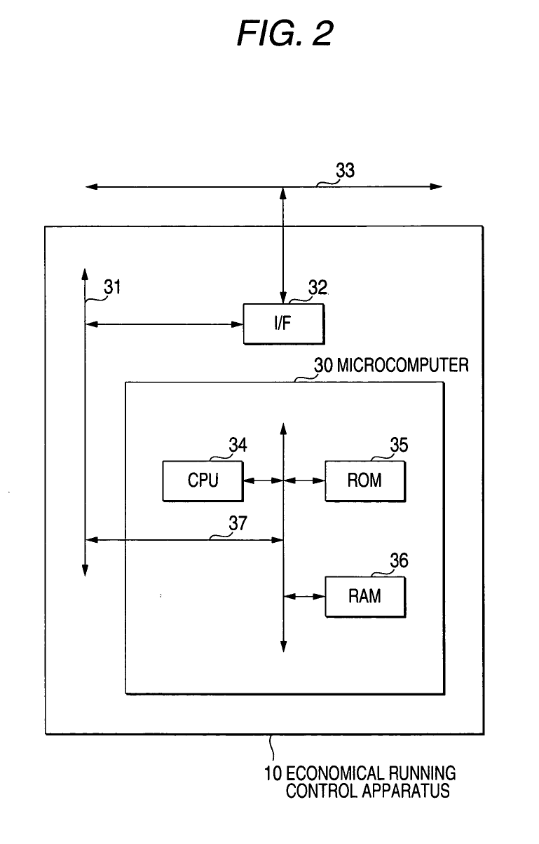

As shown in FIG. 2, the economical running control apparatus 10 includes a microcomputer 30, and this microcomputer 30 is connected to a bus 31 within the economical running control apparatus 10 and is then connected to an exterior signal line 33 via an I/F (Interface) 32.

The microcomputer 30 has a CPU (Central Processing Unit) 34, and a ROM (Read Only Memory) 35 and a RAM (Random Access Memory) 36 are connected to the CPU 34 via a bus 37 within the microcomputer 30. In addition, the bus 31 is connected to the CPU 34 via the bus 37.

The CPU 34 controls the whole of the economical running control apparatus 10. Programs of an OS (Operating System) which is executed by the CPU 34 and at least a part of an application program are temporarily stored in the RAM 36. In addition, various data which is necessary for processing by the CPU 34 is stored in the RAM 36. The programs of the OS and the application program are stored in the ROM 35.

The application program includes programs for a primary battery state detection process, a secondary battery state detection process, a voltage reduction quantity calculation process and an economical running permission determination process which are executed by the economical running control apparatus 10.

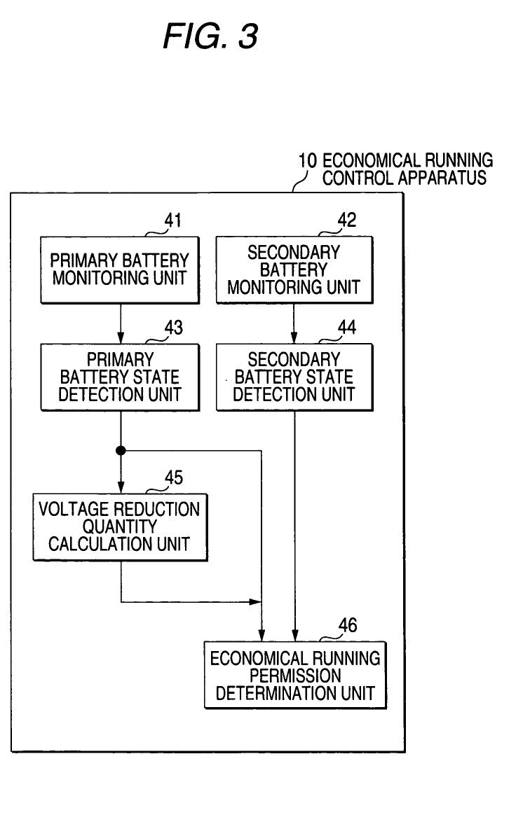

As shown in FIG. 3, the economical running control apparatus 10 includes a primary battery monitoring unit 41 (first monitor), a secondary battery monitoring unit 42 (second monitor), a primary battery state detection unit 43 (first calculator), a secondary battery state detection unit 44 (second calculator), a voltage reduction quantity calculation unit 45 (third calculator) and an economical running permission determination unit 46 judge).

The primary battery state monitoring unit 41 samples a primary battery voltage value, a primary battery current value and a battery fluid temperature of the primary battery 13 which are detected by the voltage sensor 16, the current sensor 17 and the temperature sensor 18, respectively. In addition, the secondary battery state monitoring unit 42 samples a secondary battery voltage value, a secondary battery current value and a battery ambient temperature of the secondary battery 14 which are detected by the voltage sensor 19, the current sensor 20 and the temperature sensor 21, respectively.

Based on results of the samplings, the primary battery state detection unit 43 calculates a primary battery capacity which indicates a discharged quantity of electricity (first quantity of electricity) that is discharged from the primary battery 13 while the primary battery voltage value changes by a predetermined voltage, the secondary battery state detection unit 44 obtains (or calculates) a secondary battery capacity which indicates a dischargeable quantity of electricity (second quantity of electricity) which the secondary battery 14 can discharge, and the voltage reduction quantity calculation unit 45 calculates a voltage reduction quantity (voltage reduction value) in voltage value of the primary battery from a start of the engine to a complete explosion of the engine.

Based on results of the calculations, the economical running permission determination unit 46 determines whether it permits or prohibits the economical running by comparing the electric quantities which can be supplied from the primary battery 13 and the secondary battery 14 for starting the engine with an quantity of electricity which is required between the start of the engine to the complete explosion of the engine.

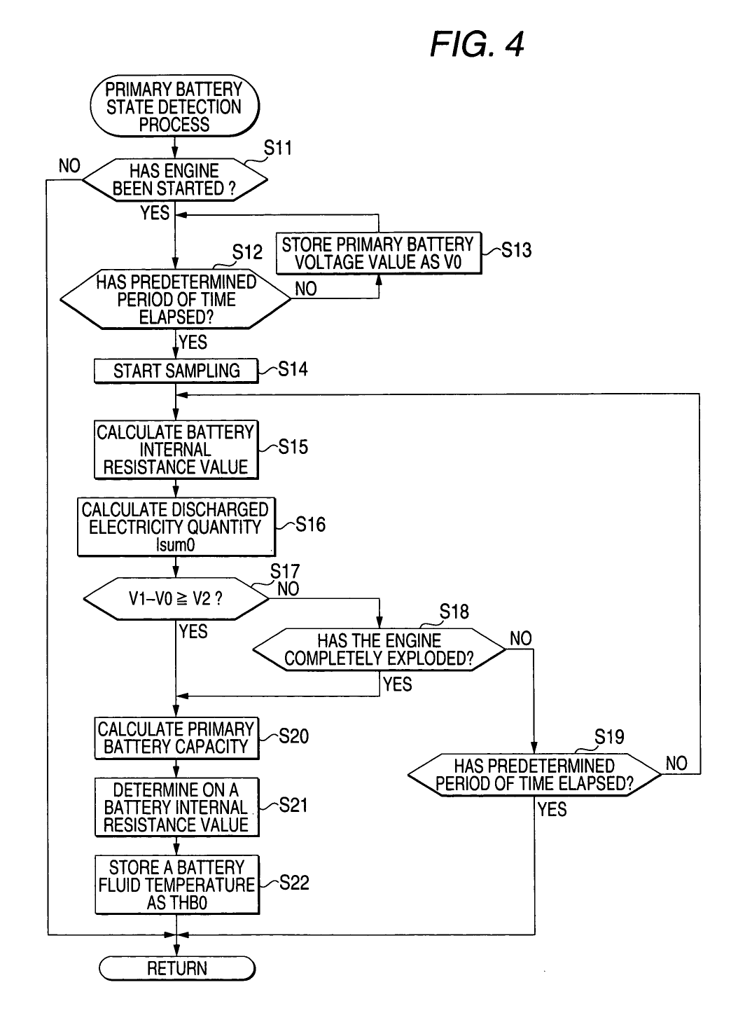

As shown in FIG. 4, the primary battery state detection unit 43 executes a process in accordance with the following steps based on a primary battery state detection process program when the engine is started by driving a starter.

[Step S11] The CPU 34 determines whether or not the engine has been started by driving the starter. If the engine is determined to have been started through drive of the starter, the process proceeds to a step S12, whereas if the engine is determined otherwise, the primary battery state detection process ends.

[Step S12] The CPU 34 determines whether or not a predetermined period of time has elapsed since the engine was started. This is because a subsequent step needs to be delayed for the predetermined period of time since the start of the engine in order to avoid the sampling of an inrush current, which flows in an initial state of the engine start, as a primary battery current value. If the predetermined period of time is determined to have elapsed, the process proceeds to a step S14, whereas if determined otherwise, the process proceeds to a step S13.

[Step S13] The CPU 34 stores the current primary battery voltage value which resulted immediately after the engine was started as a starting voltage value V0 in order to compare it with a future primary battery voltage and waits for passage of the predetermined period of time.

[Step S14] The CPU 34 starts sampling primary battery voltage values and primary battery current values which have been detected by the voltage sensor 16 and the current sensor 17, respectively.

[Step S15] The CPU 34 calculates a variation in primary battery voltage value and a variation in primary battery current value from the primary battery voltage value and the primary battery current value which have been sampled this time and the primary battery voltage value and the primary battery current value which were sampled previously and calculates a battery internal resistance value Rn by diving the variation in primary battery voltage value by the variation in primary battery current value. Namely, , the battery internal resistance value Rn is calculated as below;

Rn=(Vnow−Vold)/(Inow−Iold) (1)

where, the primary battery voltage value and the primary battery current value which have been sampled this time are Vnow (V) and Inow (A), respectively, and the primary battery voltage value and the primary battery current value which were sampled previously are Vold (V) and Iold (A), respectively. This battery internal resistance value Rn, which is calculated individually for each sampling, is sequentially accumulated, and a value for a sum Rsum of those battery internal resistance values is obtained by the following equation;

Rsum=R0+R1+R2+ . . . Rn (2)

[Step S16] The CPU 34 calculates a discharged quantity of electricity Isum0 which has been discharged from the primary battery 13 since the predetermined period of time was determined to have elapsed in the processing in the step S12 until the current point in time, that is, calculates an accumulated value of primary battery current values.

[Step S17] The CPU 34 determines whether or not the primary battery voltage value V1 which was measured in the step S14 is larger than the starting voltage value V0 by a predetermined value V2. If the primary battery voltage value V1 is determined to be so larger, the process proceeds to a step S20, whereas if smaller, the process proceeds to a step S18.

[Step S18] The CPU 34 determines whether or not there has occurred the complete explosion of the engine. If the complete explosion is determined to have occurred, the process proceeds to the step S20, whereas if not, the process proceeds to a step S19.

[Step S19] The CPU 34 determines whether or not a predetermined period of time has elapsed since the sampling was started. This is because when a state continues for the predetermined period of time in which there has occurred no complete explosion since the engine was started, there exists a possibility of occurrence of a problem that the engine has not yet been started and with such a problem, the primary battery state detection process needs to be ended. If the predetermined period of time is determined to have elapsed, the primary battery state detection process ends, whereas the predetermined period of time is determined otherwise, the process returns to the step S15.

In the steps that have been described heretofore, the sampling of the primary battery voltage value and primary battery current value, calculation of each of the battery internal resistance values and the sum thereof and calculation of the discharged quantity of electricity Isum0 are periodically performed until the difference between the current primary battery voltage value V1 and the starting voltage value V0 becomes the predetermined value V2 or the engine is completely exploded.

[Step S20] The CPU 34 calculates a primary battery capacity which indicates a discharged quantity of electricity that is discharged from the primary battery 13 while the primary battery voltage value changes by 1V by dividing the discharged quantity of electricity Isum0 calculated in the processing in the step S16 by a value which results when subtracting the starting voltage value V0 from the current primary battery voltage value V1. Namely, the primary battery capacity Cm (A sec/V) is calculated as follows;

Cm=a/(|V1−V0|)×Isum0 (3)

where, the current primary battery voltage value is V1 (V), the starting voltage value is V0 (V), and the discharged power is Isum0 (A sec),the constant a is a unit variation width of voltage in the primary battery 13, and here, a=1.

[Step S21] The CPU 34 determines on a battery internal resistance value. In this embodiment, this battery internal resistance value is made to be a mean value obtained by dividing the value of the sum Rsum of battery internal resistance values which was calculated in the processing in the step S15 by the number n of samples. Of course, this battery internal resistance value may take a maximum value or a mode value, or the battery internal resistance value may be determined after deleting those of the battery internal resistance values which depart too far.

[Step S22] The CPU 34 stores the current battery fluid temperature as THB0 for comparison with a future battery fluid temperature.

With the processes that have been described heretofore, the primary battery capacity and the battery internal resistance value are obtained based on the primary battery voltage values and the primary battery current values which were measured since the start of the engine until the primary battery voltage value was recovered from the starting voltage value after the passage of the predetermined period of time or the engine is completely exploded, and finally, the battery fluid temperature is obtained, whereby the state of the primary battery 13 is detected.

Here, since the battery internal resistance value changes at all times to match changes in the primary battery current value and the battery fluid temperature, the battery internal resistance value so calculated needs to be updated by a battery internal resistance value which matches the changes.

Next, a battery internal resistance value updating process by the primary battery state detection unit 43 will be described.

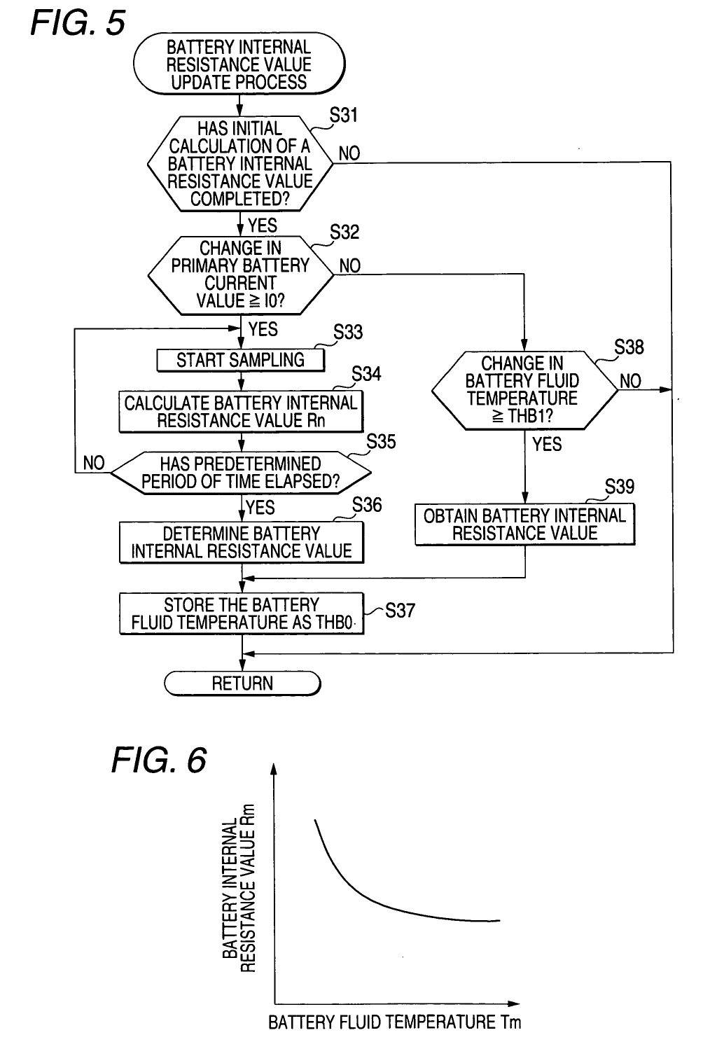

As shown in FIG. 5, the primary battery state detection unit 43 repeatedly executes a process which follows steps below based on the primary battery state detection process program.

[Step S31] The CPU 34 determines whether or not an initial calculation of a battery internal resistance value has been completed. If determined to have been completed, the process proceeds to a step S32, whereas if determined otherwise, the battery internal resistance value updating process ends here.

[Step S32] The CPU 34 determines whether or not a difference between the current primary battery current value and the primary battery current value which resulted when the battery internal resistance value was determined is a predetermined value I0 or more. Note that here, when the primary battery current value has changed by the predetermined value I0 or more, the battery internal resistance value has been also changed to match the change of the primary battery current value, and therefore, the battery internal resistance value needs to be updated. If the difference is equal to or more than the predetermined value I0, the process proceeds to a step S33, whereas if the difference is less than the predetermined value I0, the process proceeds to a step S38.

[Step S33] The CPU 34 starts sampling primary battery voltage values and primary battery current values which have been detected by the voltage sensor 16 and the current sensor 17, respectively.

[Step S34] The CPU 34 calculates a battery internal resistance value Rn. This battery internal resistance value Rn (V/A) is calculated by the previously described equation (1). Following this, a value for a sum Rsum of the battery internal resistance values so calculated is then calculated by the previously described equation (2).

[Step S35] The CPU 34 determines whether or not a predetermined period of time has elapsed since the sampling was started. This determination is made due to the primary battery voltage and the primary battery current value being sampled at a predetermined period over the predetermined period of time. If the predetermined period of time is determined to have elapsed, the process proceeds to a step 536, whereas if the predetermined period of time is determined not to have elapsed, the process returns to the step S33.

In the steps heretofore, the sampling of the primary battery voltage value and primary battery current value and calculation of the individual battery internal resistance values and the sum thereof are implemented periodically until the predetermined period of time has elapsed since the engine was started.

[Step S36] The CPU 34 determines a battery internal resistance value. In this embodiment, this battery internal resistance value is made to be a mean value obtained by dividing the value of the sum Rsum of battery internal resistance values which was calculated in the processing in the step S34 by the number n of samples. Of course, this battery internal resistance value may take a maximum value or a mode value, or the battery internal resistance value may be determined after deleting those of the battery internal resistance values which depart too far.

[Step S37] The CPU 34 stores the current battery fluid temperature as THB0 for comparison with a future battery fluid temperature.

[Step S38] The CPU 34 determines whether or not a difference between the current battery temperature and the battery fluid temperature which resulted when the battery internal resistance value was determined is a predetermined value THB1 or more. Note that here, when the battery fluid temperature changes by the predetermined value THB1 or more, the battery internal resistance value has also been changed to match the change of the battery fluid temperature, and therefore, the battery internal resistance value needs to be updated. If the difference is determined to be equal to or more than the predetermined value THB1, the process proceeds to a step S39, whereas if the difference is determined to be less than the predetermined value THB1, the battery internal resistance value updating process ends.

Here, as is shown in FIG. 6, the primary battery 13 has temperature characteristics in which the battery internal resistance value changes to mach the change in the battery fluid temperature. This temperature characteristic data is stored in the ROM 35 in the form of a table in which the battery fluid temperature is related to the battery internal resistance.

[Step S39] The CPU 34 temporarily updates the battery internal resistance value by obtaining a battery internal resistance value which corresponds to the battery fluid temperature by referring to the temperature characteristic data.

The processing carried in this step S39 is such as to temporarily update the battery internal resistance value by a theoretical value in place of an actual value when the battery internal resistance value cannot be updated because the primary battery current value does not change irrespective of the fact that the battery fluid temperature is changing. For example, when a vehicle is driven at constant speeds for hours as when running on a highway, since the engine speed remains constant, the power generation quantity of the alternator 11 changes little, whereby the primary battery current value is made difficult to change, and this makes it difficult for the process to proceed to the step S36, the battery internal resistance value being thereby made difficult to be updated. In order to avoid a situation in which the battery internal resistance value is not updated when the battery fluid temperature changes largely in these situations, the battery internal resistance value is temporarily updated in the processing carried out in the step S39. Note that when the process can proceed to the step S36 in any of subsequent cycles to the temporary update after the battery internal resistance value has been temporarily updated, the battery internal resistance value is updated by an actual value which is available then.

With the processes described above, when the primary battery current value changes, the battery internal resistance value is updated in accordance with the change in the primary battery current value, and when the variation in the battery fluid temperature is large while the variation in the primary battery current value is small, the battery internal resistance value is updated to a battery internal resistance value which corresponds to the battery fluid temperature, so that the battery internal resistance value is designed to be updated to a most updated battery internal resistance value at all times.

Next, a primary battery capacity correcting process by the primary battery state detection unit 43 will be described.

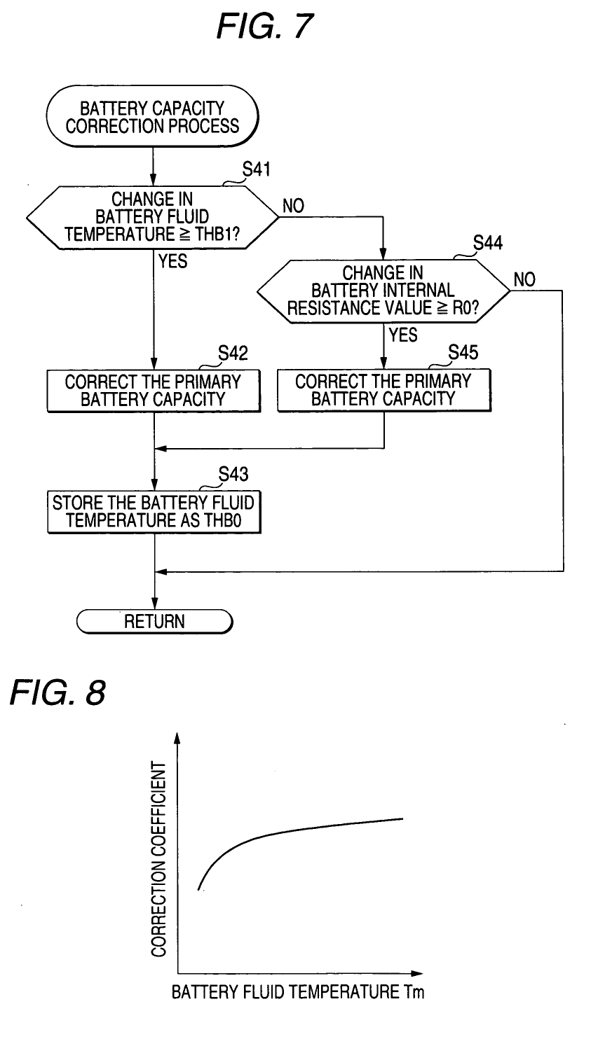

As shown in FIG. 7, the primary battery state detection unit 43 executes repeatedly a process which follows steps below based on the primary battery state detection process program.

Here, since the primary battery 13 has the temperature characteristics, the primary battery capacity changes in such a manner as to match a change in the battery fluid temperature. In order to have the primary battery capacity match the change, the primary battery capacity needs to be corrected in accordance with the battery fluid temperature.

The primary battery 13 has a tendency that ions in the interior of the primary battery 13 get easier to be activated as the battery fluid temperature Tm increases, whereby the primary battery capacity is increased. Because of this, as is shown in FIG. 8, a correction coefficient for correction of the primary battery capacity is made to increase as the battery fluid temperature increases. This temperature characteristic data is stored in the ROM 35 in the form of a table in which the battery fluid temperature is related to the correction coefficient.

[Step S41] The CPU 34 determines whether or not a difference between the current battery fluid temperature and the battery fluid temperature which resulted when the primary battery capacity was calculated is the predetermined value THB1 or more. Here, if the change in the battery fluid temperature is equal to or more than the predetermined value THB1, since the primary battery capacity has changed to match the change in the battery fluid temperature, the process proceeds to a step S42 to correct the primary battery capacity, whereas if the change is less than the predetermined value THB1, the process proceeds to a step S44.

[Step S42] The CPU 34 obtains a correction coefficient of the primary battery capacity which corresponds to the battery fluid temperature by referring to the temperature characteristic data stored in advance in the ROM 35. Following this, the CPU 34 corrects the primary battery capacity by multiplying the primary battery capacity by the correction coefficient so obtained.

[Step S43] The CPU 34 stores the current battery fluid temperature as THB0 for comparison with a future battery fluid temperature.

Here, since the primary battery 13 has the characteristics in which the primary battery capacity changes with change in the battery internal resistance value, the primary battery capacity has been changed to match the change in the battery internal resistance value. In order to reflect the change in the primary battery capacity thereon, the primary battery capacity needs to be corrected in accordance with the battery internal resistance value.

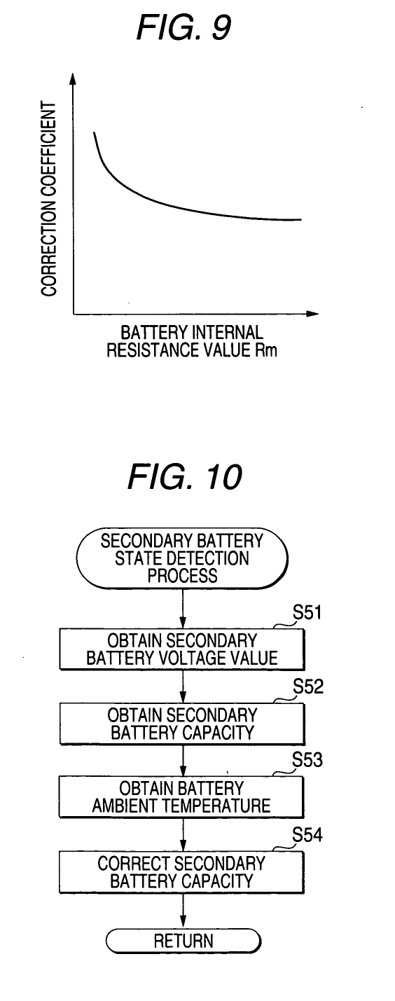

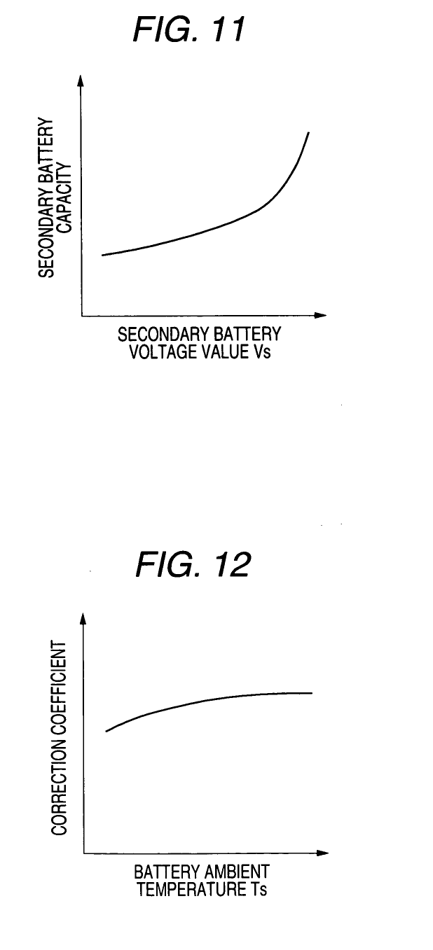

The primary battery 13 has a tendency that the primary battery current value decreases as the battery internal resistance value Rm increases, whereby the primary battery capacity decreases. Because of this, as is shown in FIG. 9, a correction coefficient for correction of the primary battery capacity is made to decrease as the battery internal resistance value increases. This characteristic data is stored in the ROM 35 in the form of a table in which the battery internal resistance value is related to the correction coefficient.

[Step S44] The CPU 34 determines whether or not a difference between the current battery internal resistance value and the primary battery capacity which resulted when the primary battery capacity was calculated is a predetermined value R0 or more. Here, if the change in the battery internal resistance value is equal to or more than the predetermined value R0, since the primary battery capacity has been also changed to match the change in the battery internal resistance value, the process proceeds to a step S45 to correct the primary battery capacity, whereas if the change is less than the predetermined value R0, the primary battery capacity correction process ends.

[Step S45] The CPU 34 obtains a correction coefficient of the primary battery capacity which corresponds to the battery internal resistance value by referring to the characteristic data stored in advance in the ROM 35. Following this, the CPU 34 corrects the primary battery capacity by multiplying the primary battery capacity by the coefficient so obtained.

With the above processes, when battery fluid temperature changes largely, the primary battery capacity is corrected to a primary battery capacity which corresponds to the battery fluid temperature so changed, and when the battery internal resistance value changes largely with the battery fluid temperature changing little, the primary battery capacity is corrected to a primary battery capacity which corresponds to the battery internal resistance value so changed, whereby the primary battery capacity is designed to be corrected to a most updated primary battery capacity at all times.

Next, a process by the secondary battery state detection unit 44 will be described.

As shown in FIG. 10, the secondary battery state detection unit 44 executes repeatedly a process which follows steps below based on a secondary battery state detection process program.

[Step S51] The CPU 34 obtains a secondary battery voltage value detected by the voltage sensor 19.

[Step S52] The CPU 34 obtains a secondary battery capacity which indicates a dischargeable quantity of electricity that the secondary battery 14 can discharge. Namely, as is shown in FIG. 11, since the secondary battery 14 has a characteristic in which the secondary battery capacity changes with secondary battery voltage value Vs, the CPU 34 obtains (or calculates) a secondary battery capacity which corresponds to the secondary battery voltage obtained thereby by referring to the secondary battery's characteristic data stored in the ROM 35.

[Step S53] The CPU 34 obtains a secondary battery ambient temperature detected by the temperature sensor 21. This is because since the secondary battery 14 also has inconsiderably temperature characteristics, the secondary battery capacity needs to be corrected to match the secondary battery voltage value in accordance with the secondary battery ambient temperature. In addition, the temperature characteristic data is stored in the ROM 35.

[Step S54] The CPU 34 obtains a correction coefficient of the secondary battery capacity relative to the battery ambient temperature by referring to the ROM 35 and corrects the dischargeable quantity of electricity that the secondary battery 14 can discharge, that is, the secondary battery capacity by multiplying the secondary battery capacity obtained in the step S52 by the correction coefficient so obtained.

With the above processes, the state of the secondary battery 14 is detected by obtaining the secondary battery capacity which corresponds to the secondary battery voltage value and the battery ambient temperature.

Next, the voltage reduction quantity calculation unit 45 performs a calculation of a voltage reduction quantity of the primary battery 13 when the starter is driven. A necessary discharged quantity of electricity which is necessary when the starter is driven can be obtained from the voltage reduction quantity so calculated.

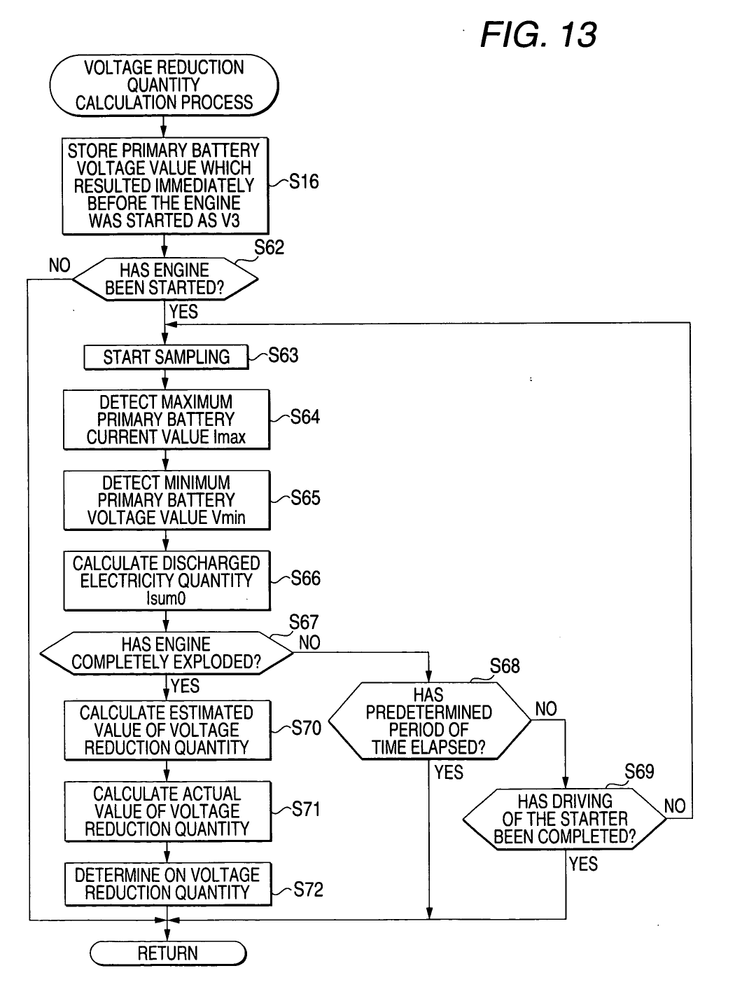

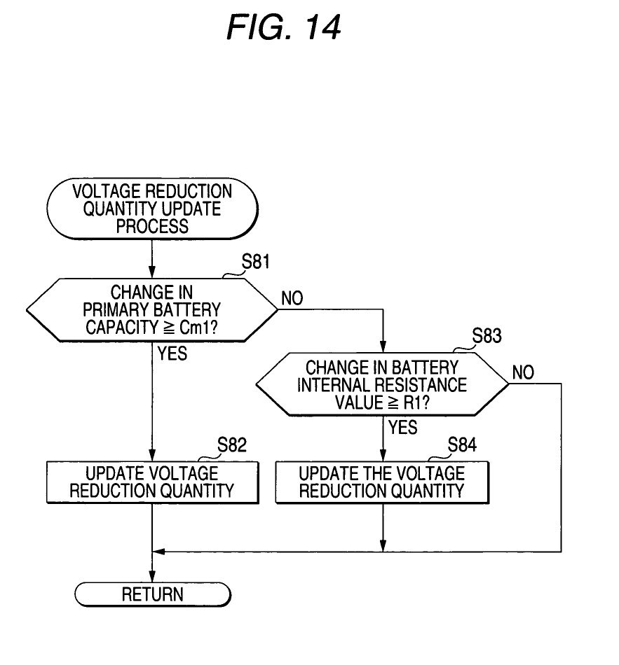

As shown in FIG. 13, the voltage reduction quantity calculation unit 45 executes a process in accordance with steps below based on a voltage reduction quantity calculation process program.

[Step S61] The CPU 34 stores the primary battery voltage value which resulted immediately before the engine was started as V3 for comparison with a future primary battery voltage value.

[Step S62] The CPU 34 determines whether or not the engine has been started by driving the starter. If determined to have been so started, the process proceeds to a step S63, whereas if determined otherwise, the voltage reduction quantity calculation process ends.

[Step S63] The CPU 34 starts sampling primary battery voltage values and primary battery current values which have been detected by the voltage sensor 16 and the current sensor 17, respectively.

[Step S64] The CPU 34 detects a maximum primary battery current value as Imax from the primary battery current values so sampled.

[Step S65] The CPU 34 detects a minimum voltage value as Vmin from the primary battery voltage values so sampled.

[Step S66] The CPU 34 calculates a discharged quantity of electricity Isum0 that has been discharged from the primary battery 13 since the engine was started until the current point in time.

[Step S67] The CPU 34 determines whether or not a complete explosion has been produced in the engine. If determined to have been produced, the process proceeds to a step S70, whereas if determined otherwise, the process proceeds to a step S68.

[Step S68] The CPU 34 determines whether or not a predetermined period of time has elapsed since the sampling was started. When a state that the engine is not completely exploded since the engine is started, continues for the predetermined period of time, there is a possibility of a problem that the starter is not driven properly. When such a problem really occurs, the voltage reduction quantity calculation process needs to end. Therefore, if the CPU 34 determines that the predetermined period of time has elapsed, the voltage reduction quantity calculation process ends, and if the CPU 34 determines that the predetermined period of time has not elapsed, the process proceeds to a step S69.

[Step S69] The CPU 34 determines whether or not the starter drive has been completed. The starter drive is implemented while the engine is started until the engine is completely exploded. In a case where the starter drive is completed although the engine is not completely exploded, there is a possibility of a problem that the starter is not driven properly. When such a problem really occurs, the voltage reduction quantity calculation process needs to end. When the engine is not completely exploded, if the CPU 34 determines that the starter drive has been completed, the voltage reduction quantity calculation process ends, and if the CPU 34 determines that the starter drive has been determined that the starter drive has not been completed yet, the process returns to the step S63.

[Step S70] The CPU 34 calculates an estimated value of a voltage reduction quantity of the primary battery voltage value by dividing the discharged quantity of electricity Isum0 by the primary battery capacity. Namely, an estimated value Vd1 (V) of a voltage reduction quantity of the primary battery voltage value is calculated as below;

Vd1=Isum0/Cm (4)

where, the primary battery capacity is Cm.

[Step S71] The CPU 34 calculates an actual value of the voltage reduction quantity of the primary battery voltage value by subtracting a minimum primary battery voltage value Vmin from the primary battery voltage value V3 which resulted immediately before the engine was started. Namely, an actual value Vd2 of the voltage reduction quantity of the primary battery is calculated as bellow;

Vde=V3−Vmin (5)

where, the primary battery voltage value V3 which resulted immediately before the engine was started is V3 (V) and the minimum primary battery voltage value is Vmin (V)

[Step S72] The CPU 34 determines on a voltage reduction quantity of the primary battery voltage value. This voltage reduction quantity is determined based on the estimated value of voltage reduction quantity calculated by the processing in the step S70 and the actual value of voltage reduction quantity calculated in the step S71. Here, a comparison is made between the estimated value of voltage reduction quantity calculated by the processing in the step S70 and the actual value of voltage reduction quantity calculated in the step S71, and a larger value is determined to be the voltage reduction quantity of the primary battery voltage value. Note that the voltage reduction quantity that is determined here may be a mean value of the estimated value of voltage reduction quantity and the actual value of voltage reduction quantity.

With the above processes, the maximum primary battery current value Imax that had been discharged from the primary battery 13 since the starter was driven until the starter drive was completed when the starter was driven and the voltage reduction quantity of the primary battery voltage value.

Here, since the voltage reduction quantity changes at all times with changes in the primary battery capacity and the battery internal resistance value, the voltage reduction quantity so calculated needs to be updated by a voltage reduction quantity which matches the changes in the primary battery capacity and the battery internal resistance value.

Next, a voltage reduction quantity update process by the voltage reduction quantity calculation unit 45 will be described.

As shown in FIG. 14, the voltage reduction quantity calculation unit 45 executes repeatedly a process in accordance with steps below based on the voltage reduction quantity calculation process program.

[Step S81] The CPU 34 determines whether or not a difference between the current primary battery capacity and the primary battery capacity which resulted when the voltage reduction quantity was calculated is equal to or more than a predetermined Cm1. Here, since when the primary battery capacity changes by the predetermined value Cm1 or more, the voltage reduction quantity of the primary battery voltage value has been also changed to match the change in the primary battery capacity, the voltage reduction quantity of the primary battery voltage value needs to be updated. When the difference is equal to or more than the predetermined value Cm1, the process proceeds to a step S82, whereas if the difference is less than the predetermined value Cm1, the process proceeds to a step S83.

[Step S82] The CPU 34 updates the voltage reduction quantity of the primary battery voltage value by recalculating a voltage reduction quantity of the primary battery voltage value by dividing the discharged current quantity Isum0 which resulted when the voltage reduction quantity was calculated by the current primary battery capacity.

[Step S83] The CPU 34 determines whether or not a difference between the current battery internal resistance value and the battery internal resistance value which resulted when the voltage reduction quantity was calculated is equal to or more than a predetermined value R1. Here, since when the battery internal resistance value changes by the predetermined value R1 or more, the voltage reduction quantity of the primary battery voltage value is understood to also have changed to match the change in the battery internal resistance value, the process of updating the voltage reduction quantity of the primary battery voltage value needs to be performed. If the difference is the predetermined value R1 or more, the process proceeds to a step S84, whereas if the difference is less than the predetermined value R1, the voltage reduction quantity update process ends.

[Step S84] The CPU 34 updates the voltage reduction quantity of the primary battery voltage value by multiplying the maximum primary battery current value Imax which resulted when the voltage reduction quantity was calculated by the current battery internal resistance value to thereby recalculate a voltage reduction quantity of the primary battery voltage value.

With the above processes, when the primary battery capacity has changed by the predetermined value Cm1 or more after the completion of starter drive or when the battery internal resistance value has changed by the predetermined value R1 or more while the primary battery capacity has not changed, the voltage reduction quantity of the primary battery voltage value that has already been calculated is updated, so as to be kept updated to the voltage reduction quantity corresponding to the current primary battery voltage value.

Based on the states of the primary battery and the secondary battery, which are obtained from the processes that have been described heretofore, the economical running permission determination unit 46 executes a determination process of whether an economical running is permitted or prohibited.

The economical running permission determination unit 46 contains a primary economical running permission determination process and/or a secondary economical running permission determination process program, and these programs are selected as required.

Firstly, a primary economical running permission determination process by the economical running permission determination unit 46 will be described.

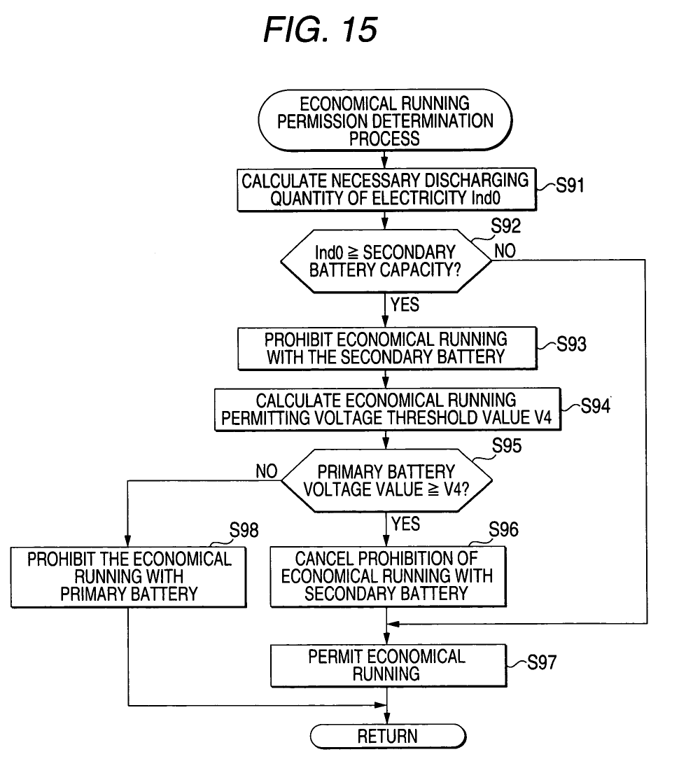

As shown in FIG. 15, the economical running permission determination unit 46 executes repeatedly a process in accordance with steps below based on the economical running permission determination process program.

[Step S91] The CPU 34 calculates a necessary discharging quantity of electricity Ind0 which is to be discharged by the primary battery 13 when the starter is driven. This necessary discharging quantity of electricity Ind0 (A sec) is calculated by multiplying the voltage reduction quantity calculated in the processing in the step S72 by the primary battery capacity, and the necessary discharging quantity of electricity Ind0 is expressed as below;

Ind0=Vd×Cm (6)

where, the voltage reduction quantity of the primary battery voltage value is Vd (V).

[Step S92] The CPU 34 determines whether or not the necessary discharging quantity of electricity Ind0 is equal to or more than the secondary battery capacity (the dischargeable quantity of electricity of the secondary battery 14). If determined to be smaller, since the whole of the necessary discharging quantity of electricity that the primary battery 13 is to discharge can completely covered by the dischargeable quantity of electricity of the secondary battery 14, the process proceeds to a step S97, whereas if determined to be larger, the process proceeds to a step S93.

[Step S93] Since when the necessary discharging quantity of electricity Ind0 is equal to or more than the secondary battery capacity, the secondary battery 14 cannot completely assist the primary battery 13, the CPU 34 prohibits an economical running by the dischargeable quantity of electricity of the secondary battery 14.

[Step S94] The CPU 34 calculates an economical running permitting voltage threshold value V4 (threshold value) which can permit an economical running by a dischargeable quantity of electricity of the primary battery 13. This economical running permitting voltage threshold value V4 is calculated by adding the voltage reduction quantity calculated in the processing in the step S72 to a lowest voltage determination voltage value. It is determined that the primary battery voltage value cannot become lower than the lowest voltage determination voltage value when the starter is driven. Namely, the lowest voltage determination voltage value means a minimum value of the voltage value of the first battery.

[Step S95] The CPU 34 determines whether or not the primary battery voltage value is equal to or more than the economical running permitting voltage threshold value V4. If determined to be more, it means that the primary battery 13 itself holds the whole of the necessary discharging quantity of electricity that the primary battery 13 is to discharge, and the process proceeds to a step S96, whereas if determined to be smaller, the process proceeds to a step S98.

[Step S96] The CPU 34 cancels the prohibition of the economical running by the dischargeable quantity of electricity of the secondary battery 14.

[Step S97] The CPU 34 permits the economical running by the discharging quantity of electricity from the primary battery 13 or the economical running by the dischargeable quantity of electricity of the secondary battery 14. [Step S98] The CPU 34 prohibits the economical running by the discharging quantity of electricity from the primary battery 13.

In this way, the economical running permission determination unit 46 firstly determines whether or not the engine can be restarted only by the secondary battery 14, and although the economical running by the secondary battery 14 is prohibited, when the primary battery voltage value is equal to or more than the economical running permitting voltage threshold value, the economical running permission determination unit 46 cancels the prohibition of the economical running by the secondary battery 14 so as to permit the economical running, whereby even though the economical running is permitted to stop the engine, since the primary battery 13 or the secondary battery 14 holds the necessary discharging quantity of electricity that is to be discharged by the primary battery 13 when the starter is driven, the restart of the engine can be ensured when attempting to restore the normal driving by the engine from the economical running.

Next, a secondary economical running permission determination process by the economical running permission determination unit 46 will be described.

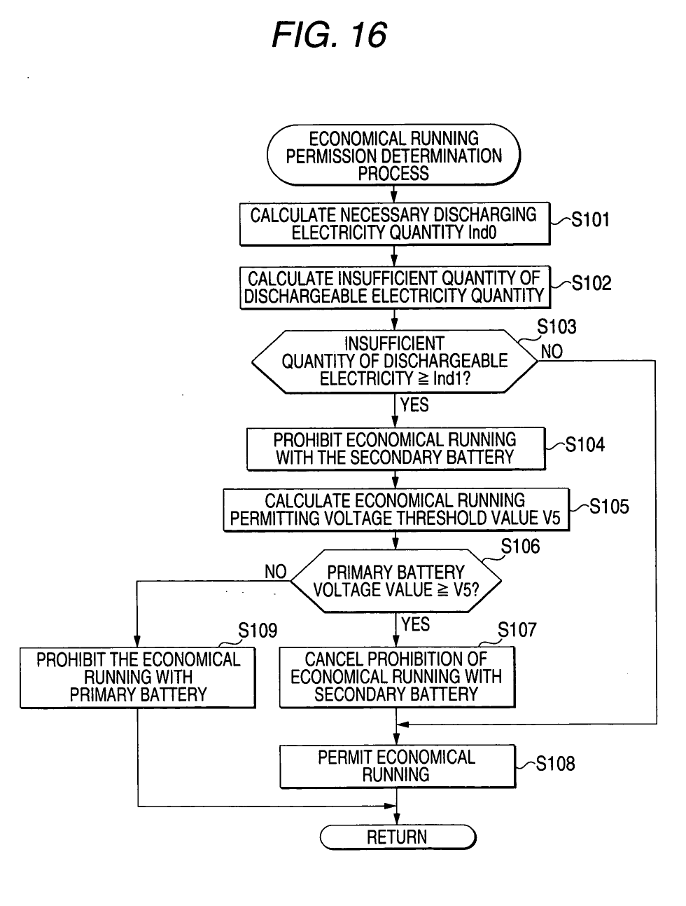

As shown in FIG. 16, the economical running permission determination unit 46 executes repeatedly a process in accordance with steps below based on the economical running permission determination process program.

[Step S101] The CPU 34 calculates a necessary discharging quantity of electricity Ind0 that the primary battery 13 is to discharge when the starter is driven. This necessary discharging quantity of electricity Ind0 is calculated by multiplying the voltage reduction quantity calculated in the voltage reduction quantity calculation processing in the step 72 by the primary battery capacity.

[Step S102] The CPU 34 calculates an insufficient quantity of dischargeable power of the secondary battery 14 (fourth quantity of electricity) when the starter is driven. This insufficient quantity of dischargeable power is calculated by subtracting the secondary battery capacity (the dischargeable quantity of electricity of the secondary battery 14) which was calculated in the processing in the step 53 from the necessary discharging quantity of electricity Ind0.

[Step S103] The CPU 34 determines whether or not the insufficient quantity of dischargeable power is equal to or more than a predetermined value Ind1. If determined to be less, since the whole of the necessary discharging power amount that the primary battery 13 is to discharge can sufficiently be covered by the dischargeable quantity of electricity of the secondary battery 14, the process proceeds to a step S108, whereas if determined to be more, the process proceeds to a step S104.

[Step s104] Since when the insufficient quantity of dischargeable power is equal to or more than the predetermined value Ind1, the secondary battery 14 cannot sufficiently assist the primary battery 13, the CPU 34 prohibits the economical running by the dischargeable quantity of electricity of the secondary battery 14.

[Step S105] The CPU 34 calculates an economical running permitting voltage threshold value V5 (threshold value) which can permit an economical running by the discharging quantity of electricity of the primary battery 13. This economical running permitting voltage threshold value V5 is calculated by dividing the insufficient quantity of dischargeable quantity of electricity by the primary battery capacity and adding the lowest voltage determination voltage value to the result of the division. Namely, the economical running permitting voltage threshold value V5 (V) is calculated as below;

V5=Vt+(If/Cm) (7)

where, the insufficient quantity of dischargeable power is If (A sec), the lowest voltage determination voltage value is Vt (V), the primary battery capacity is Cm.

[Step S106] The CPU 34 determines whether or not the primary battery voltage value is equal to or more than the economical running permitting voltage threshold value V5. If determined to be more, it means that the primary battery 13 and the secondary battery 14 hold the whole of the discharging quantity of electricity that the primary battery 13 is to discharge, and the process proceeds to a step s107, whereas if determined to be less, the process proceeds to a step S109.

[Step S107] The CPU 34 cancels the prohibition of the economical running by the dischargeable quantity of electricity of the secondary battery 14.

[Step S108] The CPU 34 permits the economical running by the discharging quantity of electricity of the primary battery 13 or the economical running by the dischargeable quantity of electricity of the secondary battery 14.

[Step S109] The CPU 34 prohibits the economical running by the discharging quantity of electricity of the primary battery 13.

In this way, the economical running permission determination unit 46 firstly determines from the insufficient quantity of dischargeable power whether or not the engine can be restarted only by the secondary battery 14, and even though the economical running by the secondary battery 14 is prohibited, when primary battery voltage value is equal to or more than the economical running permitting voltage threshold value, the economical running permission determination unit 46 cancels the prohibition of the economical running by the secondary battery 14 so as to permit the economical running, whereby even though the economical running is permitted to stop the engine, since the primary battery 13 or the secondary battery 14 holds the necessary discharging quantity of electricity that the primary battery 13 is to discharge when the starter is driven, the restart of the engine can be ensured when attempting to restore the normal driving by the engine from the economical running.

Next, an in-economical running capacity update process by the economical running permission determination unit 46 will be described.

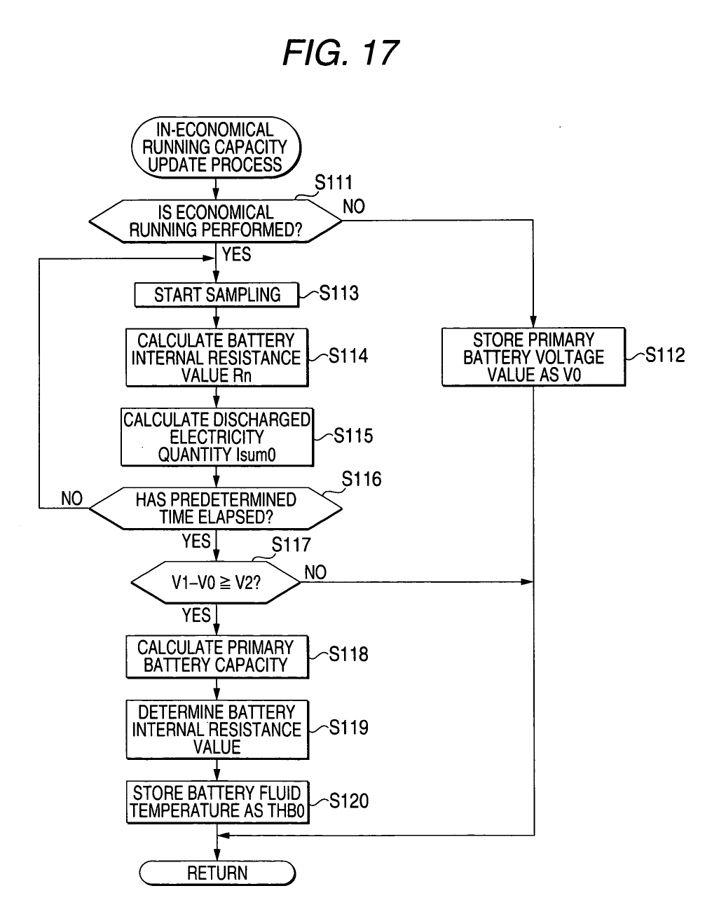

As shown in FIG. 17, the economical running permission determination unit 46 executes repeatedly a process which follows steps below while the economical running is in operation based on the economical running permission determination program.

[Step S111] The CPU 34 determines whether or not the economical running is in operation. If determined to be in operation, the process proceeds to a step S113, whereas if determined otherwise, the process proceeds to a process S112.

[Step S112] The CPU 34 stores the primary battery voltage value which resulted before the economical running was put in operation as a starting voltage value V0 for comparison with a future primary battery value.

[Step S113] The CPU 34 calculates a battery internal resistance value Rn. This battery internal resistance value Rn (V/A) is calculated by the previously described equation (1). Following this, a value of a sum Rsum of the battery internal resistance values so calculated is then calculated by the previously described equation (2).

[Step S114] The CPU 34 calculates a battery internal resistance value Rn. This battery internal resistance value Rn (V/A) is calculated in the previously described equation (1). Following this, a value for a sum Rsum of battery internal resistance values is calculated in the previously described equation (2).

[Step S115] The CPU 34 calculates a discharged quantity of electricity Isum0 which has been discharged from the primary battery 13 since the sampling was started until the current point in time.

[Step S116] The CPU 34 determines whether or not a predetermined length of time has elapsed since the start of sampling. This is because the primary battery voltage value and the primary battery current value are sampled at a predetermined period over the predetermined length of time. If determined that the predetermined length of time has elapsed, the process proceeds to a step S117, whereas if determined that the predetermined length of time has not elapsed, the process returns to the step s113.

In the steps described heretofore, the sampling of the primary battery voltage value and primary battery current value, calculation of the individual battery internal resistance values and the sum thereof and calculation of the discharged quantity of electricity are designed to be implemented periodically.

[Step S117] The CPU 34 determines whether or not the primary battery voltage value V1 is larger than the starting voltage value V0 by a predetermined value V2. If determined to be larger, the necessity occurs of determining whether to permit or prohibit the continuation of economical running due to there being a large change in the primary battery voltage value, and the process proceeds to a step S118, whereas if determined to be smaller, the in-economical running capacity update process ends.

[Step S118] The CPU 34 calculates a primary battery capacity which indicates a discharged quantity of electricity which is discharged from the primary battery while the primary battery voltage value changes by 1V by dividing the discharged power amount Isum0 which was calculated in the processing in the step S115 by a value which results when subtracting the starting voltage value V0 from the current primary battery voltage value V1. This primary battery capacity Cm (A sec/V) is calculated by the previously described equation (3).

[Step S119] The CPU 34 determines on an battery internal resistance value. In this embodiment, this battery internal resistance value is made to be a mean value obtained by dividing the value of the sum Rsum of battery internal resistance values which was calculated in the processing in the step S114 by the number n of samples. Of course, this battery internal resistance value may take a maximum value or a mode value, or the battery internal resistance value may be determined after deleting those of the battery internal resistance values which depart too far.

[Step S120] The CPU 34 stores the current battery fluid temperature as THB0 for comparison with a future battery fluid temperature.

In the above processes, in such a situation that a decrease in the primary battery voltage value is expected during the implementation of economical running, when the primary battery voltage value is decreased to less than the predetermined value, the primary battery capacity and the battery internal resistance value are updated.

Next, an automatic engine restarting process by the economical running permission determination unit 46 will be described.

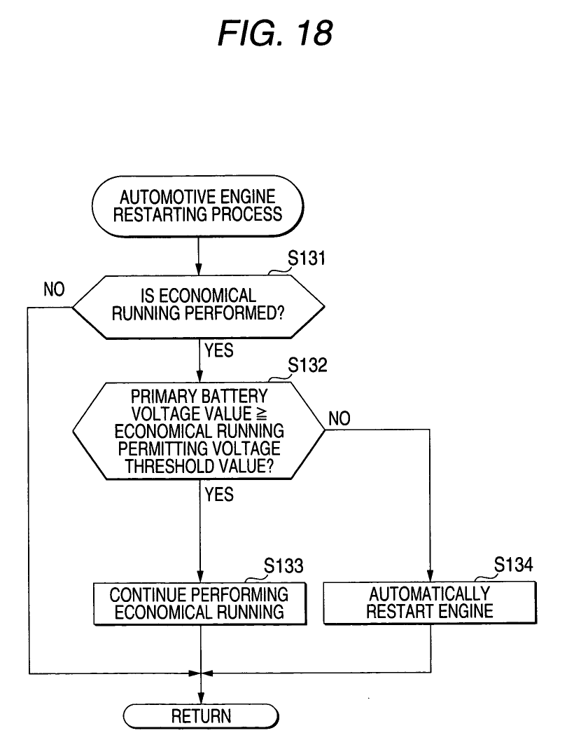

As shown in FIG. 18, the economical running permission determination unit 46 executes repeatedly a process which follows steps below while the economical running is in operation based on the economical running permission determination process program.

[Step S131] The CPU 34 determines whether or not the economical running is in operation. If determined that the economical running is in operation, the process proceeds to a step S132, whereas if determined otherwise, the automatic engine restarting process ends.

[Step S132] The CPU 34 determines whether or not the primary battery capacity is equal to or more than the economical running permitting voltage threshold value which was calculated in the processing in the step S94 or step S105. If determined to be more, it means that the primary battery 13 or the secondary battery 14 holds an quantity of electricity that is necessary from start of the engine to occurrence of a complete explosion in the engine, and the process proceeds to a step S133, whereas if determined to be less, the process proceeds to a step S134.

[Step S133] The CPU 34 permits the continuation of the economical running.

[Step S134] The CPU 34 prohibits the continuation of the economical running and forcibly restarts the engine.

With the above processes, when the primary battery voltage value is equal to or more than the economical running permitting voltage threshold value, the implementation of economical running is allowed to continue, whereas when the primary battery voltage value is less than the economical running permitting voltage threshold value, the engine is forcibly restarted, whereby as long as the primary battery 13 and the secondary battery 14 hold the sufficient quantity of electricity while the economical running is in operation, the economical running can continue.

Note that while in the description that has been made heretofore, the economical running control apparatus 10 is described as being configured as a single unit, the invention is not limited thereto and hence, a configuration may be adopted in which the economical running control apparatus 10 is integrated with the engine control system for controlling the engine. In addition, another configuration may be adopted in which a power supply management system for controlling the batteries and the alternator 11 is separated from the economical running control apparatus 10.

What is claimed is:

1. An economical running control apparatus operable to control an economical running in which an engine is automatically stopped when a predetermined engine stopping condition is established and the engine is automatically started when a predetermined engine starting condition is established, the economical running control apparatus adapted to be mounted on a vehicle including the engine, a first battery operable to supply power to an vehicle mounted electric unit, and a second battery operable to suppress a voltage reduction in the first battery when the engine is started, the economical running control apparatus comprising:
a judge operable to judge whether the economical running is permitted or prohibited based on a first quantity of electricity which the first battery is capable of discharging when the engine is started, a second quantity of electricity which the second battery is capable of discharging, and a third quantity of electricity required to completely explode the engine.

2. The economical running control apparatus as set forth in claim 1, further comprising:
a first monitor operable to monitor a voltage value of the first battery, a current value of the first battery, and a fluid temperature of the first battery;
a second monitor operable to monitor a voltage value of the second battery, a current value of the second battery, and an ambient temperature of the second battery;
a first calculator operable to calculate the first quantity of electricity based on the voltage value of the first battery, the current value of the first battery, and the fluid temperature of the first battery;
a second calculator operable to calculate the second quantity of electricity based on the voltage value of the second battery, the current value of the second battery, and the ambient temperature of the second battery;
a third calculator operable to calculate a voltage reduction value of the first battery when the engine is completely exploded, wherein:
the third quantity of electricity is calculated based on the voltage reduction value.

3. The economical running control apparatus as set forth in claim 2, wherein:
the judge operable to calculate the third quantity of electricity based on the voltage reduction value and the first quantity of electricity;
when the third quantity of electricity is smaller than the second quantity of electricity, the judge permits the economical running to perform with the second battery; and
when the third quantity of electricity is equal to or larger than the second quantity of electricity, the judge prohibits the economical running to perform with the second battery.

4. The economical running control apparatus as set forth in claim 3, wherein:
when the voltage value of the first battery is larger than a threshold value, the judge permits the economical running to perform with the first battery.

5. The economical running control apparatus as set forth in claim 4, wherein:
the judge operable to calculate the threshold value based on a minimum value of the voltage value of the first battery and the voltage reduction value of the first battery.

6. The economical running control apparatus as set forth in claim 2, wherein:
the judge operable to calculate the third quantity of electricity based on the voltage reduction value and the first quantity of electricity;
the judge operable to calculate a fourth quantity of electricity based on the third quantity of electricity and the second quantity of electricity;
when the fourth quantity of electricity is smaller than a predetermined value, the judge permits the economical running to perform with the second battery; and
when the fourth quantity of electricity is larger than a predetermined value, the judge permits the economical running to perform with the second battery.

7. The economical running control apparatus as set forth in claim 6, wherein:
when the voltage value of the first battery is larger than a threshold value, the judge permits the economical running to perform with the first battery.

8. The economical running control apparatus as set forth in claim 7, wherein:
the judge operable to calculate the threshold value based on a minimum value of the voltage value of the first battery, the fourth quantity of electricity, and the first quantity of electricity.

9. An economical running control method for a vehicle including an engine, a first battery operable to supply power to a starter, and a second battery operable to additionally supply power to the first battery, if required, the economical running control method comprising:
permitting an economical running in which the engine is automatically stopped when a predetermined engine stopping condition is established and the engine is automatically started when a predetermined engine restarting condition is established;
prohibiting the economical running; and
judging whether the economical running is permitted or prohibited based on a voltage value of the first battery.

10. The economical running control method as set forth in claim 9, further comprising:
judging whether the economical running is permitted or prohibited based on a voltage value of the second battery,
permitting the economical running when the economical running is permitted based on at least one of the voltage value of the first battery and the voltage value of the second battery;
prohibiting the economical running when the economical running is prohibited based on both the voltage value of the first battery and the voltage value of the second battery.
